(19) United States
(12) Patent Application Publication
(10) Pub. No.: US 2026/0046792 A1
(43) Pub. Date: Feb. 12, 2026

(54) CHANNEL STRUCTURES FOR SIDELINK SYNCHRONIZATION SIGNAL BLOCKS IN LISTEN-BEFORE-TALK OPERATIONS

(71) Applicant: ZTE CORPORATION, Shenzhen, Guangdong (CN)

(72) Inventors: Yuzhou HU, Shenzhen, Guangdong (CN); Haigang HE, Shenzhen, Guangdong (CN); Youxiong LU, Shenzhen, Guangdong (CN); Weimin XING, Shenzhen, Guangdong (CN)

(21) Appl. No.: 18/998,294

(22) PCT Filed: Nov. 4, 2022
(86) PCT No.: PCT/CN2022/129737

§ 371 Date: Jan. 24, 2025

(51) Int. Cl. H04W 56/00; H04W 74/0808

(52) U.S. Cl. CPC H04W 56/001; H04W 74/0808

(57) ABSTRACT

Presented are systems, methods, apparatuses, or computer-readable media for performing listen-before-talk (LBT) operations in sidelink communications. A wireless communication device may perform a LBT operation with respect to a sidelink synchronization signal block (S-SSB) having a first part and a second part. The first part may repeat one or more symbols from the second part according to a configuration of the second part. The wireless communication device may determine a failure in the LBT operation at a first point in the S-SSB. The wireless communication device may determine a success in the LBT operation at a second point of the S-SSB subsequent to the first point. The wireless communication device may transmit, responsive to the success, at least a portion of the S-SSB mapped to one or more time-domain resources starting from the second point.

### TECHNICAL FIELD

The disclosure relates generally to wireless communications, including but not limited to systems and methods for performing listen-before-talk (LBT) operations in sidelink communications.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for performing listen-before-talk (LBT) operations in sidelink communications. A wireless communication device may perform a LBT operation with respect to a sidelink synchronization signal block (S-SSB) having a first part and a second part. The first part may repeat one or more symbols from the second part according to a configuration of the second part. The wireless communication device may determine a failure in the LBT operation at a first point in the S-SSB. The wireless communication device may determine a success in the LBT operation at a second point of the S-SSB subsequent to the first point. The wireless communication device may transmit, responsive to the success, at least a portion of the S-SSB mapped to one or more time-domain resources starting from the second point.

In some embodiments, the wireless communication device may determine a second failure in the LBT operation at a third point of the S-SSB subsequent to the first point. In some embodiments, the wireless communication device may transmit, responsive to the second failure, a second portion of the S-SSB having one or more second time-domain resources subsequent to the first point. In some embodiments, the wireless communication device may drop, responsive to the success at the second point, a second portion of the S-SSB having one or more second time-domain resources starting from the second point. In some embodiments, the wireless communication device may determine a success in the LBT operation at a third point of the S-SSB subsequent to the first point. In some embodiments, the wireless communication device may transmit, responsive to the success at the third point, a second portion of the S-SSB having one or more second time-domain resources starting from the third point.

In some embodiments, the first part of the S-SSB may repeat the one or more symbols of a type of a plurality of types for sidelink synchronization. The plurality of types may include at least one of a sidelink primary synchronization signal (S-PSS) or a sidelink secondary synchronization signal (S-SSS). In some embodiments, the first part of the S-SSB may repeat the one or more symbols from the second part according to the configuration of the first part. In some embodiments, the first part of the S-SSB repeating the one or more symbols from the second part may start from an initial symbol index and may end at a terminal symbol index, prior to an initial symbol of a physical sidelink broadcast channel (PSBCH).

In some embodiments, the transmission of the S-SSB may only apply to a second set of S-SSB. In some embodiments, the second set of S-SSB may be on the slots which are not mapped by a bitmap associated with a resource pool. In some embodiments, the transmission of the entirety of a first set of S-SSB may be performed when the second point corresponds to the initial symbol index. In some embodiments, the first set of S-SSB may be on the slots which are mapped by a bitmap associated with a resource pool. In some embodiments, only a single starting point for PSSCH/PSCCH may be configured or predefined/used on the slots where the first set of S-SSB is transmitted/configured/predefined.

In some embodiments, the wireless communication device may transmit, responsive to the success at the second point corresponding to the initial symbol index, an entirety of the S-SSB mapped to the one or more time-domain resources. In some embodiments, the wireless communication device may drop at least one initial symbol corresponding to the initial symbol index from transmission, responsive to (i) the LBT failure at the first point corresponding to the initial symbol index and (ii) the LBT success at the second point corresponding to at least one index subsequent to the initial symbol index. In some embodiments, the wireless communication device may drop at least some time domain resources which is a multiple of 9 us or 16 us subsequent to the first point from transmission, responsive to (i) the LBT failure at the first point and (ii) the success at the second point corresponding to a multiple of 9 us or 16 us subsequent to the first point.

In some embodiments, the first part of the S-SSB may repeat a repetition range corresponding to the one or more symbols from the second part based on at least one of a number of symbols, subcarrier spacing, number of RBs, or a number of interlaces for mapping. In some embodiments, a first number of S-SSBs not belonging to a resource pool and a second number of S-SSBs belonging to a resource pool may be separately configured or predefined. In some embodiments, a mapping ratio between a first number of S-SSBs not belonging to a resource and a second number of S-SSBs belonging to a resource pool may be configured or predefined.

In some embodiments, the first number defined within a resource block (RB) set or a bandwidth part (BWP) may be different from or same as the second number of symbols. In some embodiments, the first point and the second point may be identified from a plurality of candidate starting points for the LBT operation. Each candidate starting point may be defined within at least one of a resource block (RB) set or a bandwidth part (BWP).

In some embodiments, a first number of candidate starting points for the LBT operation in a first RB set may be smaller than a second number of candidate starting points in a second RB set. In some embodiments, a first location of at least one first candidate starting point for the LBT operation in a first RB set may be earlier than a second location of at least one second candidate starting point in a second RB set. In some embodiments, a larger number of candidate starting points or an earlier location of candidate starting point(s) may correspond to a higher priority or less LBT failure of S-SSB on the slots which are not mapped by a bitmap associated with a resource pool or on the slots which are mapped by a bitmap associated with a resource pool. In some embodiments, the aforementioned S-SSB on slots which are not mapped by a bitmap are associated with S-SSB on slots which are mapped by a bitmap.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of a network architecture for sidelink communications in accordance with an illustrative embodiment;

FIG. 4 illustrates a block diagram of a channel structure of a sidelink synchronization signal block (S-SSB) in accordance with an illustrative embodiment;

FIG. 5 illustrates a block diagram of resource elements in a sidelink synchronization signal block (S-SSB) in accordance with an illustrative embodiment;

FIG. 6A illustrates a block diagram of a sidelink synchronization signal block (S-SSB) with a repetition range containing a single type of synchronization signal occupying an entire frequency range, in accordance with an illustrative embodiment;

FIG. 6B illustrates a block diagram of a sidelink synchronization signal block (S-SSB) with a repetition range containing interlaced (e.g., not the same synchronization signals on all symbols within the repetition range) multiple types of synchronization signal and a physical sidelink broadcast channel (PSBCH) occupying different frequency range segments, in accordance with an illustrative embodiment;

FIG. 6C illustrates a block diagram of a sidelink synchronization signal block (S-SSB) with a repetition range containing non-interlaced (e.g., same synchronization signal on all symbols within the repetition range) single type of synchronization signal and physical sidelink broadcast channel (PSBCH) occupying different frequency range segments, in accordance with an illustrative embodiment;

FIG. 6D illustrate a block diagram of a sidelink synchronization signal block (S-SSB) with a repetition range containing interlaced (e.g., not the same synchronization signals on all symbols within the repetition range) multiple types of synchronization signals and physical sidelink broadcast channel (PSBCH) occupying an entire frequency range, in accordance with an illustrative embodiment;

FIG. 7A illustrates a block diagram of a sidelink synchronization signal block (S-SSB) with a first part repeating multiple types of synchronization signals and physical sidelink broadcast channel (PSBCH) from a second part occupying different frequency segments and symbols, in accordance with an illustrative embodiment;

FIG. 7B illustrates a block diagram of a sidelink synchronization signal block (S-SSB) with a first part repeating a single type of synchronization signals from a second part occupying an entire frequency segment, in accordance with an illustrative embodiment;

FIG. 7C illustrates a block diagram of a sidelink synchronization signal block (S-SSB) with a first part repeating a single type of synchronization signal and PSBCH from a second part occupying an entire frequency segment, in accordance with an illustrative embodiment;

FIG. 8 illustrates a block diagram of a sidelink synchronization signal block (S-SSB) with a repetition of symbols from a second part in a first part with symbol indices, in accordance with an illustrative embodiment;

FIG. 9A illustrates a block diagram of a sidelink synchronization signal block (S-SSB) with a dropping of a first symbol of a first part with multiple types of synchronization signals and physical sidelink broadcast channel (PSBCH) from a second part occupying different frequency segments and symbols, in accordance with an illustrative embodiment;

FIG. 9B illustrates a block diagram of a sidelink synchronization signal block (S-SSB) with a dropping of a first symbol of a first part with a single type of synchronization signals from a second part occupying an entire frequency segment, in accordance with an illustrative embodiment;

FIG. 9C illustrates a block diagram of a sidelink synchronization signal block (S-SSB) with a dropping of a first symbol of a first part with multiple types of synchronization signals from a second part occupying an entire frequency segment, in accordance with an illustrative embodiment; and

FIG. 10 illustrates a flow diagram of a method of performing listen-before-talk (LBT) operations in sidelink communications, in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

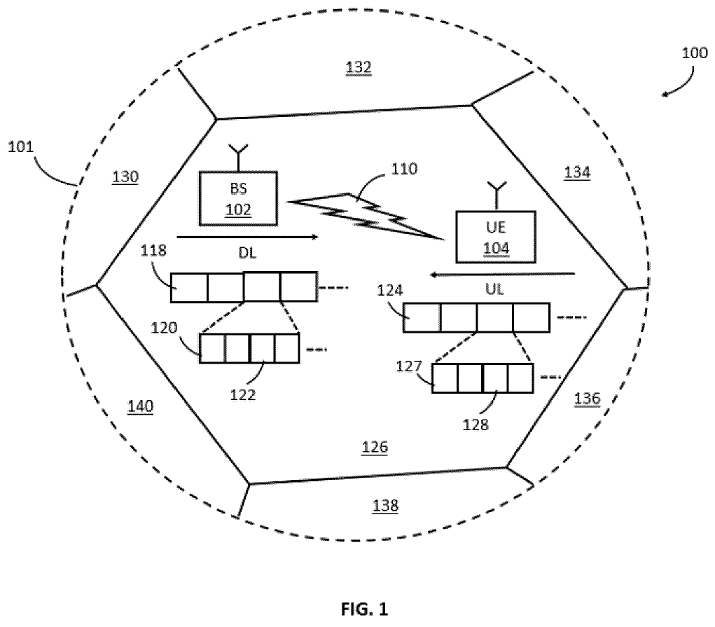

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IOT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

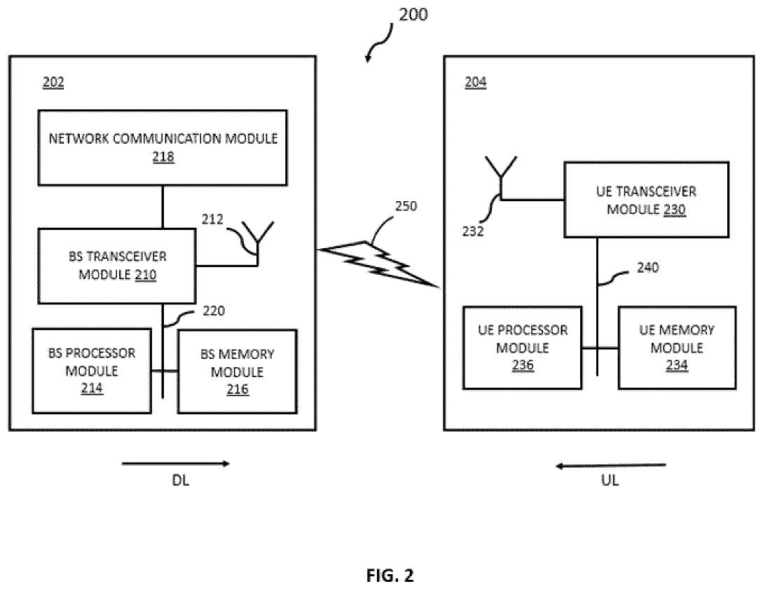

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

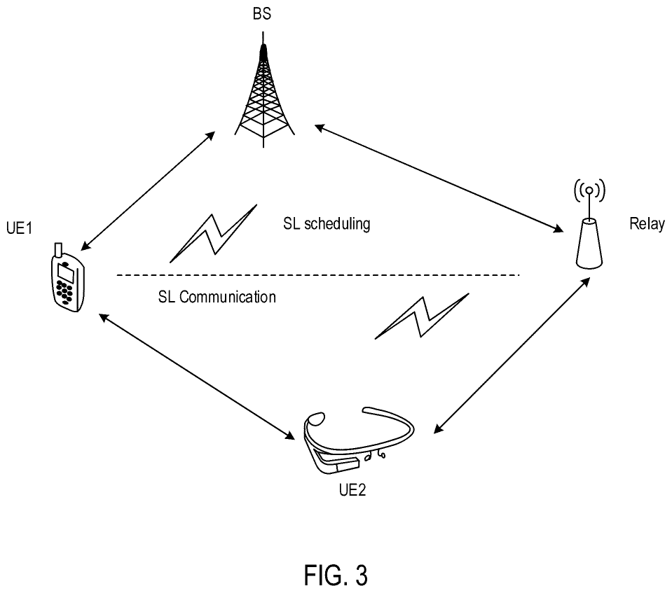

FIG. 3 shows a schematic diagram of a network architecture for sidelink communications. The network, for example as depicted, may include a base station (BS), a relay (node) (e.g., a header UE) and two UEs UE1 and UE2. For example, the UE1 may be a mobile phone and the UE2 may be a smart gadget (e.g., smart glasses). In some embodiments, the UE1 and/or UE2 may be an internet of things (IoT) device. The UE1 and UE2 may communicate with the BS directly or via a relay. Based on a sidelink (SL) scheduling received from the BS, the relay, UE1 and UE2 may communicate with each other. The communication between every two of the relays, UE1 and UE2 may be referred to as sidelink communications. The SL communication may be in the form of unicast, groupcast or broadcast, among others. Furthermore, the UE2 may communicate with the BS/relay via the UE1. That is the UE1 may act as a UE/mobile relay.

### 2. Systems and Methods for Performing Listen-Before-Talk Operations in Sidelink Communications

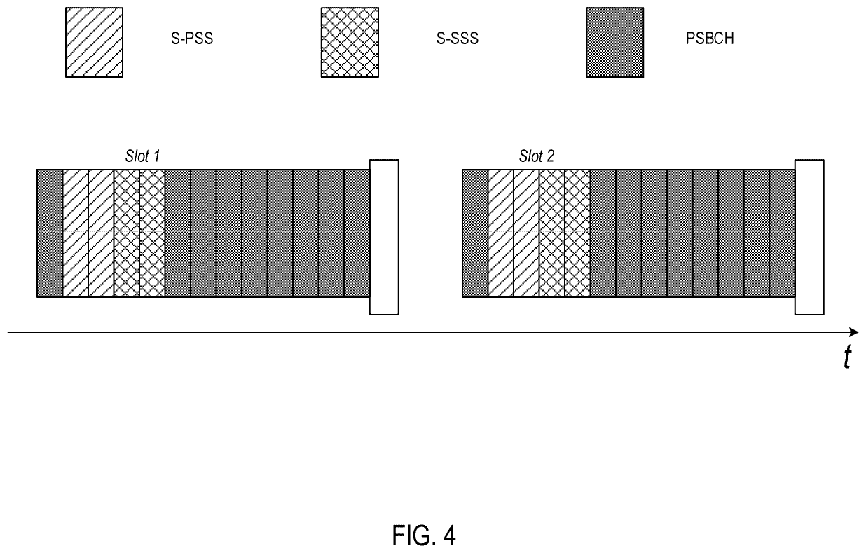

Referring now to FIG. 4, depicted is block diagram of a channel structure of a sidelink synchronization signal block (S-SSB). For sidelink synchronization signal block (S-SSB) transmission in sidelink operation over unlicensed spectrum, LBT failure may lead to failure of transmitting the physical sidelink broadcast channel (PSBCH) and synchronization signals, thereby degrading sidelink synchronization and communication performance. LBT failure may be more likely to happen compared with WiFi, which may transmit at any time instant. This may be because with a LBT operation sensing idle within a given duration prior to this time instant, S-SSB transmission may only initiate at the slot boundary starting with PSBCH at symbol 0 as shown in FIG. 3.

To increase the S-SSB channel access opportunity, some approach may be proposed to increase the number of candidate starting points of S-SSB (e.g. within a slot). In this way, when LBT operation is not successful at a given initial starting point a, LBT operation can be performed on a starting point b. The time interval between a and b may be a multiple integer of 9 μs, 16 μs, or symbols. Once the LBT operation is successful at a candidate starting point b, the S-SSB may still succeed at accessing the channel, by not transmitting the mapped signal or channel between the initial starting point a and b or transmitting only the mapped signal or channel after b.

For S-SSB transmission in sidelink operation over unlicensed spectrum, some transmission slots may be excluded from the candidate as per following procedures. Under a first procedure, the set of slots that may belong to a sidelink resource pool may be denoted by

$$( {t}_{0}^{SL} , {t}_{1}^{SL} , … , {t}_{{T}_{{max}^{- 1}}}^{SL} ) where :$$

$$0 \leq {t}_{i}^{SL} < 10240 \times {2}^{μ} , 0 \leq i < {T}_{max} ,$$

The slot index may be relative to slot 0 of the radio frame corresponding to a system frame number (SFN) 0 of the serving cell or direct frame number (DFN) 0. The set may include all the slots except the following slots, N_{S-SSB} slots in which S-SS/PSBCH block (S-SSB) may be configured.

For sidelink operation over unlicensed spectrum, there may be two types of S-SSB slots. One type of S-SSB slots may be excluded from SL (sidelink) resource pool as per the aforementioned procedure. This type of S-SSB slots may thus not be mapped by a bitmap associated with a resource pool.

Another type of S-SSB slots are be configured or predefined in the set of slots that may belong to a sidelink resource pool (e.g., not being part of the set to be excluded). This type of S-SSB slots may be thus mapped by a bitmap associated with a resource pool. Still, these S-SSB slots may be within the set of slots assigned to a sidelink resource pool and correspond to slot tₖ^{SL} whose corresponding b_{k′}=1 where k′=k mod L_{bitmap}.

Under a second procedure, the user equipment (UE) may determine the set of slots assigned to a sidelink resource pool as follows. A bitmap (b₀, b₁, . . . , b_{L}_{_{bitmap}}₋₁) associated with the resource pool may be used where L_{bitmap} the length of the bitmap may be configured by higher layers. A slot

$${t}_{k}^{SL} ( 0 \leq k < 10240 \times {2}^{μ} - {N}_{S - SSB} - {N}_{nonSL} - {N}_{reserved} )$$

belongs to the set if b_{k′}=1 where k′=k mod L_{bitmap}. The slots in the set may be re-indexed such that the subscripts i of the remaining slots t′ᵢ^{SL} are successive {0, 1, . . . , T′ₘₐₓ−1} where T′ₘₐₓ may be the number of the slots remaining in the set.

The UE may determine the set of resource blocks assigned to a sidelink resource pool. To determine, the resource block pool comprised of N_{PRB} physical resource blocks (PRBs). The sub-channel m for m=0, 1, . . . , numSubchannel−1 may include a set of n_{subCHsize} contiguous resource blocks with the physical resource block number n_{PRB}=n_{subCHRBstart}+m·n_{subCHsize}+j for j=0,1, . . . , n_{subCHsize}−1, where n_{subCHRBstart} and n_{subCHsize} are given by higher layer parameters sl-StartRB-Subchannel and sl-SubchannelSize, respectively. A UE may not be expected to use the last N_{PRB} mod n_{subCHsize} PRBs in the resource pool.

### A. Configuration of Symbols in Sidelink Synchronization Signal Blocks (S-SSB)

The configuration of symbols in sidelink synchronization signal blocks (S-SSB) in conjunction with performing a listen-before-talk (LBT) operation may be as follows. A repetition range may be predefined or configured for carrying repeated primary synchronization signal (PSS), secondary synchronization signal (SSS), or physical sidelink broadcast channel PSBCH. Predefined or configured frequency resources may be occupied by some or all of S-PSS/S-SSS/PSBCH. Configuration may include configuration through a gNB, a radio resource control (RRC), system information, or pre-configuration.

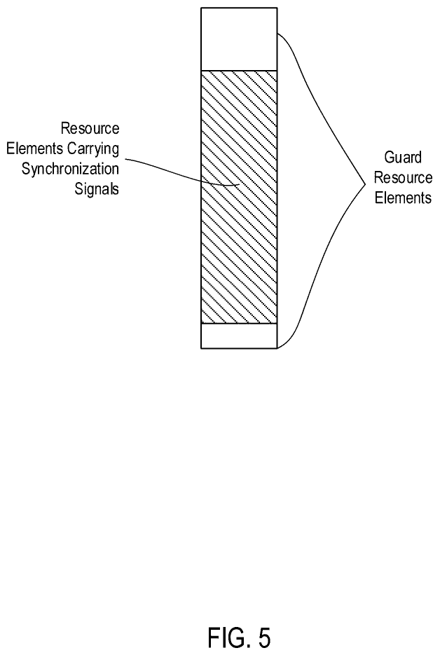

Referring now to FIG. 5, depicted is a block diagram of resource elements in a sidelink synchronization signal block (S-SSB). For instance, the sidelink PSS (S-PSS) or sidelink SSS (S-SSS) of length 127 may occupy no more than 11 resource blocks (RBs) with resource elements (Res) {0, 1, 129, 130, 131}, denoted as guard REs, set to 0. The PSBCH may occupy configured or predefined frequency range (e.g. number of interlaces). PSBCH may not be mapped to intra-cell guard RBs or REs.

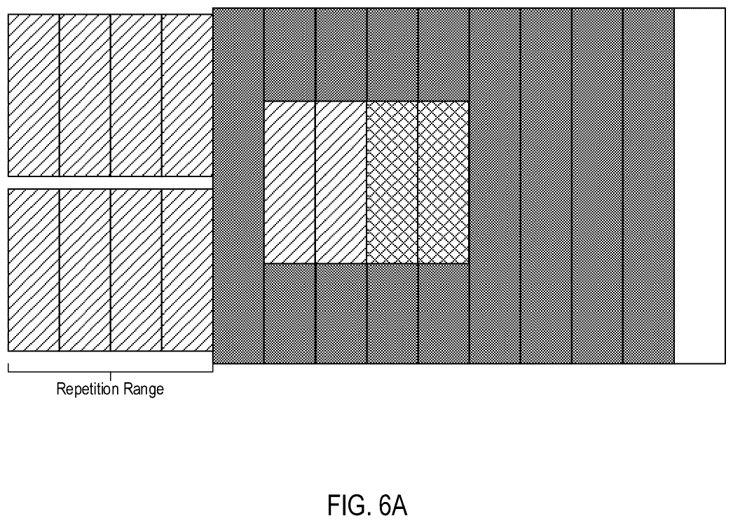

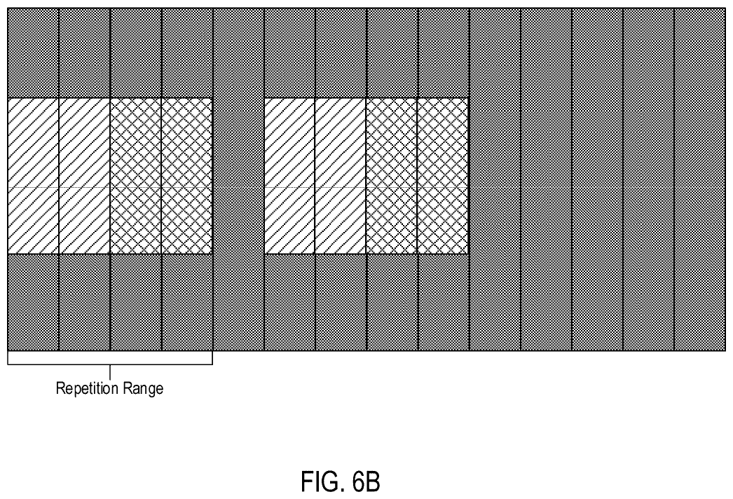

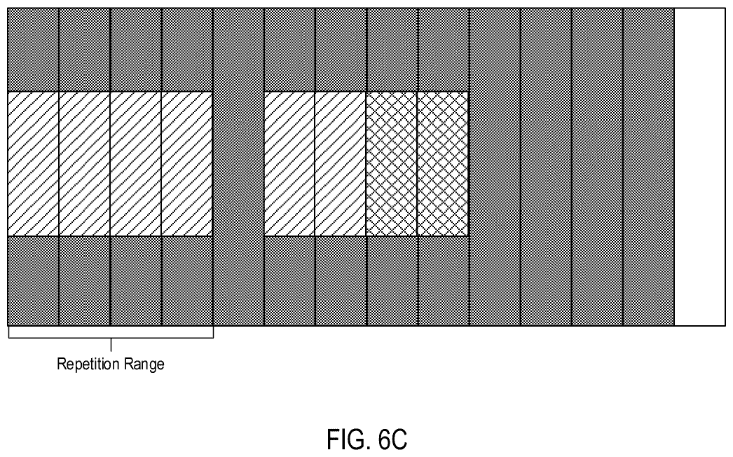

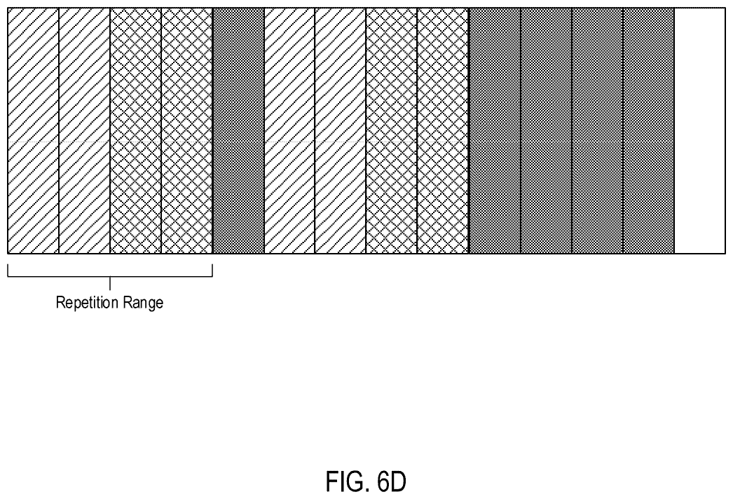

Referring now to FIG. 6A, depicted is a block diagram of a sidelink synchronization signal block (S-SSB) with a repetition range containing a single type of synchronization signal occupying an entire frequency range. The S-SSB may be mapped from a starting point (e.g., the first symbol of a slot) till the end of the slot. The S-SSB may include two parts. The first part may start from symbol k₀, and include L₀ symbols. The second part may start from symbol k₁, and include of L₁ symbols. The k₀ can take the values within the range of {0,1,2,3,4,5,6,7}.

In the first part, the S-PSS or S-SSS may be mapped to a configured or predefined frequency range (e.g., number of interlaces if configured or predefined). The S-PSS or S-SSS of length 127 may occupy no more than 11 RBs (132 REs) with REs {0, 1, 129, 130, 131} set to 0. The S-PSS or S-SSS may be repeated from (i) configured/predefined symbols and (ii) the first symbols having S-PSS or S-SSS till a last symbol containing a number of symbols the same as that in the repetition range, in the second part and further repeated in frequency domain in the first part.

Referring to FIG. 6B, depicted is a block diagram of a sidelink synchronization signal block (S-SSB) with a repetition range containing interlaced (e.g., not the same synchronization signals in all symbols within the repetition range) multiple types of synchronization signal and PSBCH occupying different frequency range segments. Referring now to FIG. 6C, depicted is a block diagram of a sidelink synchronization signal block (S-SSB) with a repetition range containing non-interlaced (e.g., the same synchronization signal on all symbols within the repetition range) single type of synchronization signal and PSBCH occupying different frequency range segments. As depicted in these examples, a set of configured predefined symbols (e.g., symbol containing S-PSS only or symbol containing S-SSS only) may be repeated from the second part to a configured predefined symbols in the first part.

Referring now to FIG. 6D, depicted is a block diagram of a sidelink synchronization signal block (S-SSB) with a repetition range containing interlaced (e.g., not the same synchronization signals in all symbols within the repetition range) multiple types of synchronization signals occupying an entire frequency range. As depicted in the example, in the second part, the S-PSS, S-SSS, or PSBCH may be mapped to a configured or predefined frequency range e.g. number of interlaces, number of resource blocks (RBs), if configured or predefined.

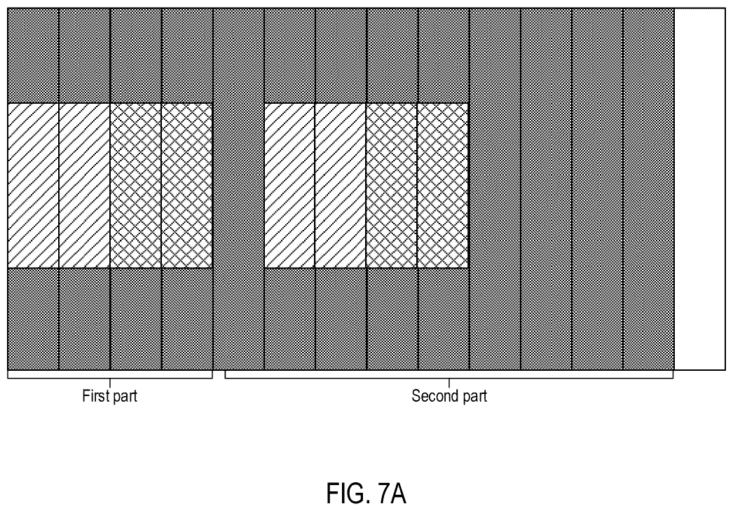

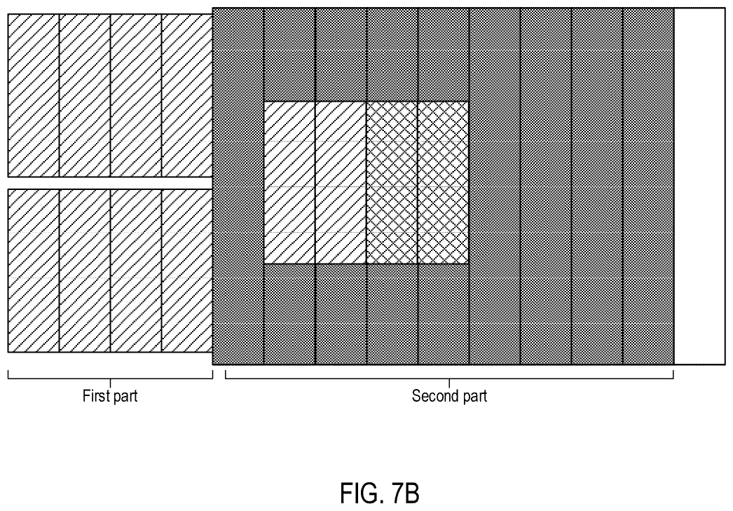

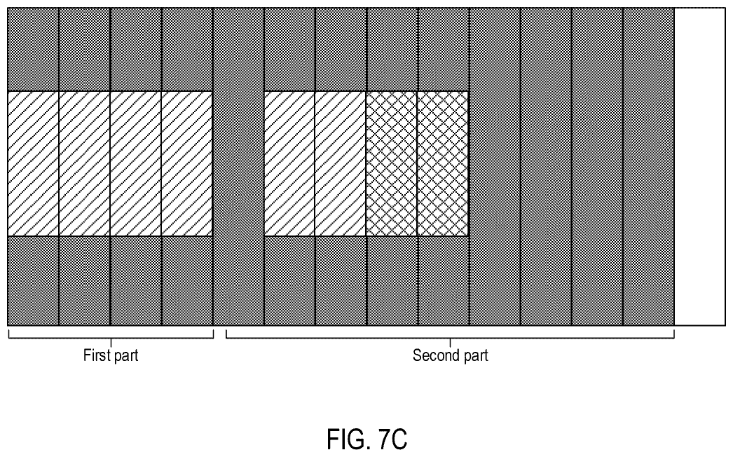

Referring now to FIG. 7A, depicted is a block diagram of a sidelink synchronization signal block (S-SSB) with a first part repeating multiple types of synchronization signals and PSBCH from a second part occupying different frequency segments. Referring also to FIG. 7B, depicted is a block diagram of a sidelink synchronization signal block (S-SSB) with a first part repeating a single type of synchronization signals from a second part occupying an entire frequency segment. In some embodiments, the S-PSS or S-SSS of length 127 may occupy no more than 11 RBs (132 REs) with REs {0, 1, 129, 130, 131} set to 0. As depicted, the symbols containing S-PSS or S-SSS may be wrapped around by PSBCH. The PSBCH may not be mapped to the REs set to 0 and shall not be mapped to intra cell guard bands between RB sets. Referring to FIG. 7C, depicted is a block diagram of a sidelink synchronization signal block (S-SSB) with a first part repeating a single type of synchronization signal and PSBCH from a second part occupying an entire frequency segment. All the symbols in the repetition range shall be repeated from the symbol with either one of S-PSS and S-SSS from the second part. This structure may have the benefit of differentiating first and second part pattern.

A configured predefined symbols (e.g., symbol containing S-PSS only or symbol containing S-SSS only) may be repeated from the second part to a configured predefined symbols in the first part. The symbols of the first part and second part can be generated, for example, repeating the second part symbols to the symbol locations in the first part and mapped to a slot structure. The symbols of the second part can be mapped to the locations within the slot and then repeated to the configured or predefined symbols in the first part to generate the slot structure.

A set of candidate starting points may be set for a UE to perform channel access, in case a listen-before-talk (LBT) operation at a given starting point does not succeed, the next starting point shall be used for LBT operation. The UE may perform the LBT at a candidate starting point (e.g. the first symbol or prior to the first symbol).

If the LBT operation succeeds, the S-SSB may be transmitted with the mapped signal or channel between an initial candidate starting point and the candidate starting point where the LBT operation succeeds dropped. Only the mapped signal or channel after the candidate starting point where the LBT operation succeeds may be transmitted. Otherwise, LBT may be performed at another candidate starting point which may be either 9 μs, 16 μs, or one symbol later in time compared with the previous starting point. The above procedure applies to the S-SSB not belonging to a resource pool, such as the S-SSB whose slots are not mapped by a bitmap associated with a resource pool. The starting symbol index for the S-SSB whose slots are not mapped by a bitmap associated with a resource pool may take the value within {0,1,2,3,4,5,6,7}.

The number of predefined or configured S-SSB not belonging to a resource pool and the number of S-SSB belonging to a resource pool (e.g., the S-SSB whose slots are mapped by a bitmap associated with a resource pool) within a given frequency range (e.g. within an RB set, a bandwidth part (BWP), or a carrier) may be configured separately. For example, the number can be the same or different. The starting symbol index for the S-SSB whose slots are mapped by a bitmap associated with a resource pool can take value 0

The configuration or predefinition of the candidate starting points from which at least one starting point can be identified may include a number of candidate starting points, locations of starting points, index of associated S-SSB in a resource pool e.g., the S-SSB whose slots are mapped by a bitmap associated with a resource pool) a priority level or the situation (e.g., number) of LBT failure operation for S-SSB belonging or not belonging to a resource pool, among others.

### B. Transmission of Sidelink Synchronization Signal Block (S-SSB) When Listen-Before-Talk (LBT) Operation Succeeds at Initial Symbol

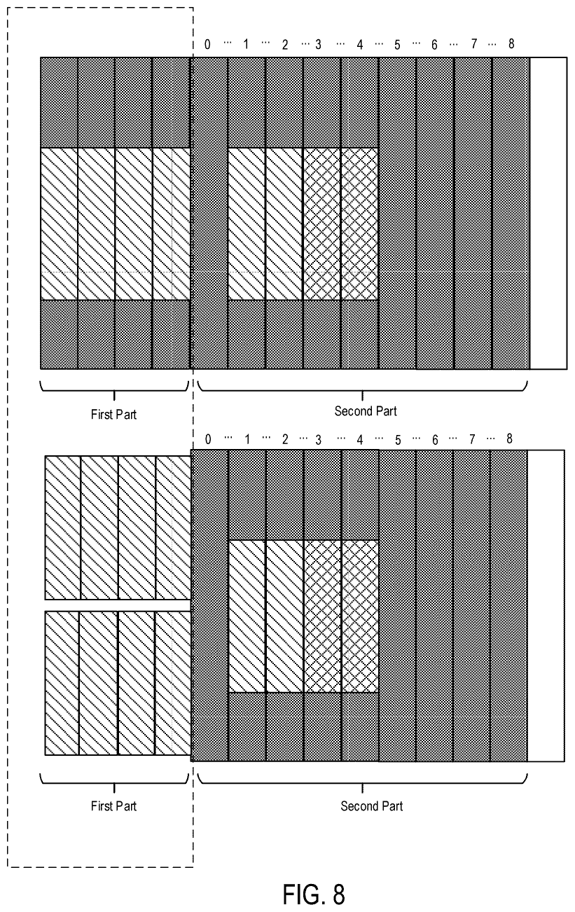

As in FIGS. 7A or 7B, the number of PSBCH may be mapped to a configured or predefined frequency resources with some number of interlaces (e.g., 2, 3, 4, or 5), number of RBs (e.g. 20, 30, 40, 50) or the number of symbols for PSBCH mapping starting from a configured or predefined symbol index later than symbol 0. The repetition range may be configured or predefined as the symbol range between symbol 0 and the last symbol prior to the starting symbol of PSBCH. Referring now to FIG. 8, depicted is a block diagram of a sidelink synchronization signal block (S-SSB) with a repetition of symbols from a second part in a first part with symbol indices. Repeated S-PSS or S-SSS from the original symbols 1-2, 3-4 according to indexing within the second part, or the symbols 5-6, 7-8 according to indexing of the whole slot may be mapped to symbols 0-1 and 2-3 respectively. In this case, when the LBT operation succeeds at symbol 0 with sensing idle within a given duration prior to symbol 0, the slot structure may be transmitted.

### C. Transmission of Sidelink Synchronization Signal Block (S-SSB) When Listen-Before-Talk (LBT) Operation Fails at Initial Symbols and Succeeds by Next Symbol

The number of PSBCH may be mapped to a configured or predefined frequency resources, with some number of interlaces (e.g., 2, 3, 4, or 5), number of RBs or the number of symbols for PSBCH mapping starting from a configured or predefined symbol index later than symbol 0. The repetition range may be configured or predefined as the symbol range between symbol 0 and the last symbol prior to the starting symbol of PSBCH. Repeated S-PSS or S-SSS from the original symbol 1-2, 3-4 according to indexing within the second part or the symbols 5-6, 7-8 according to indexing of the whole slot is mapped to symbol 0-1, 2-3 respectively. In this case, when LBT operation fails at symbol 0 and by symbol 1 with sensing idle within a given duration prior to symbol 1, the slot structure may be transmitted. The symbol S-PSS mapped to symbol 0 may be dropped, and the S-PSS, PSBCH, or S-SSS mapped from symbol 1 to the end of the slot may be transmitted.

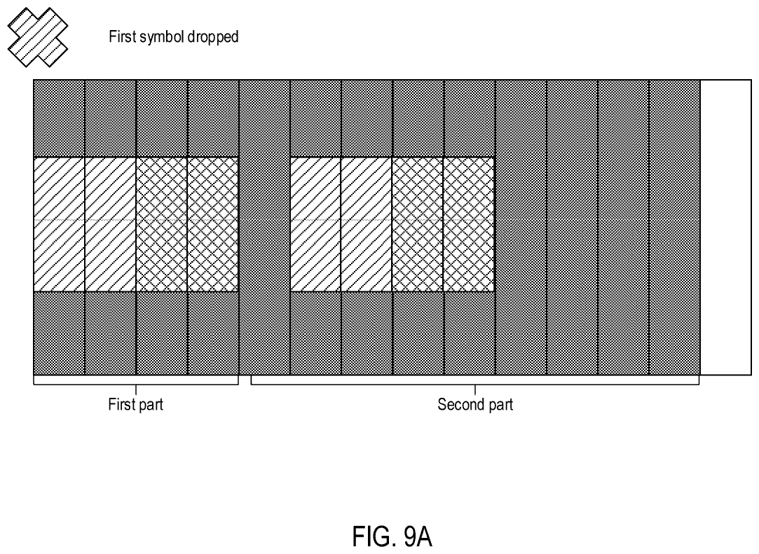

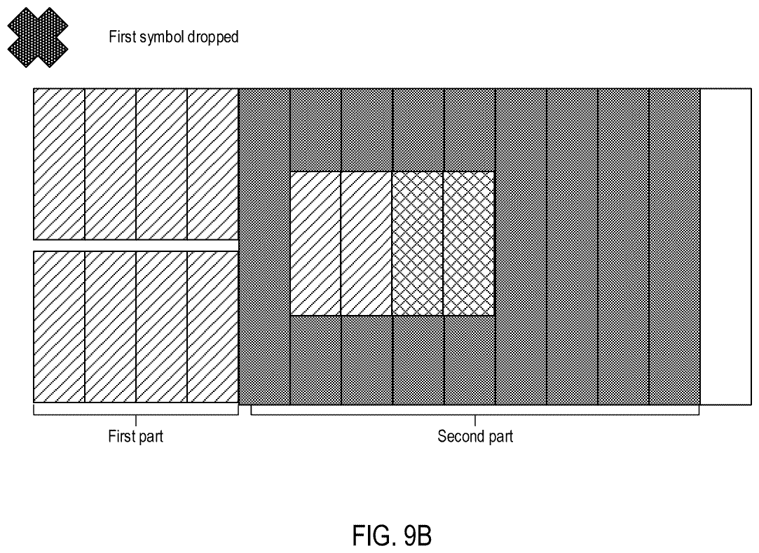

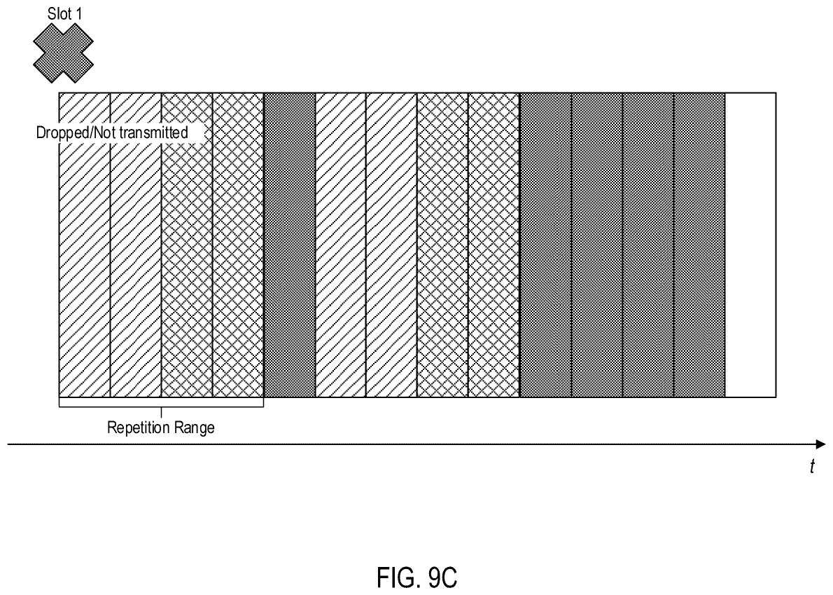

These are reflected in the depicted examples. Referring to FIG. 9A, depicted is a block diagram of a sidelink synchronization signal block (S-SSB) with a dropping of a first symbol of a first part with multiple types of synchronization signal and PSBCH from a second part occupying different frequency segments and symbols. Referring to FIG. 9B, depicted is a block diagram of a sidelink synchronization signal block (S-SSB) with a dropping of a first symbol of a first part with a single type of synchronization signals from a second part occupying an entire frequency segment. Referring to 9C, depicted is a block diagram of a sidelink synchronization signal block (S-SSB) with a dropping of a first symbol of a first part with multiple types of synchronization signals from a second part occupying an entire frequency segment.

### D. Repetition Range in Parts of Sidelink Synchronization Signal Block (S-SSB)

The number of repetition range can be predefined or configured as within {1,2,3,4,5,6,7} symbols, and may be different depending on subcarrier spacing and the number of interlaces configured or predefined for mapping the PSBCH. For example, configuring 2 symbols as the number of symbols within the repetition range may be setting number of interlaces for carrying PSBCH as 3 under 30 kHz subcarrier spacing. In such a case PSBCH may be rate matched to floor (11/15*9)=7 Orthogonal Frequency Division Multiplexing (OFDM) symbols, leaving out 2 symbols as repetition range. In another example, configuring 4 symbols as the number of symbols within the repetition range may be setting number of interlaces for carrying PSBCH as 2 under 15 kHz subcarrier spacing. In this scenario, then PSBCH may be rate matched to floor (11/20*9)=5 OFDM symbols, leaving out 4 symbols as repetition range.

Some other settings and PSBCH rate matching approach may lead to other number of repetition range such as {1,3,5,6,7} symbols. The number of OFDM symbols can be derived through an association rule between the number of interlaces or number of RBs configured/defined for mapping the PSBCH and the subcarrier spacing for the S-SSB. One or multiple symbols of S-PSS, S-SSS, or PSBCH may be mapped to symbols within the repetition range. One or more of S-PSS, S-SSS, or PSBCH may be mapped to the symbols within the repetition range.

E. Mapping of Symbols in Sidelink Synchronization Block (S-SSB) with Respect to Resource Pools

The number of S-SSBs configured or predefined not belonging to a resource pool may be larger than the number of S-SSBs configured or predefined belonging to the resource pool. A number of S-SSBs configured or predefined not belonging to a resource pool may be mapped to a number of S-SSBs configured or predefined belonging to the resource pool via a mapping ratio larger than 1 and may be located within different RB set or BWP. The slot structure in described above may apply to one or multiple S-SSBs configured or predefined not belonging to a resource pool.

### F. Configuration of Candidate Starting Points for Listen-Before-Talk (LBT) Operations

The candidate starting point for LBT operation for the multiple number of S-SSBs configured within a frequency range (e.g., in different RB set or BWP) may be configured or predefined with different starting points for LBT operation. The number of candidate starting points for LBT operation in an RB set may be smaller than the number of candidate starting points for LBT operation in another RB set.

The location of candidate starting point for LBT operation in an RB set may be earlier than the location of candidate starting points for LBT operation in another RB set. The earlier location of candidate starting point of S-SSB or the smaller number of candidate starting points for LBT operation in an RB set may correspond to a higher priority level of the S-SSB not belonging or associated S-SSB belonging to a resource pool. The earlier location of candidate starting point of S-SSB or the smaller number of candidate starting points for LBT operation in an RB set may correspond to a larger number of LBT failure by the S-SSB not belonging or associated S-SSB belonging to a resource pool. The location of candidate starting point for S-SSB may be determined based on the number of candidate starting point, the priority level of the S-SSB not belonging to or associated S-SSB belonging to a resource pool, the number of LBT failure by the S-SSB not belonging or associated S-SSB belonging to a resource pool.

### G. Process for Performing Listen-Before-Talk (LBT) Operations in Sidelink Communications

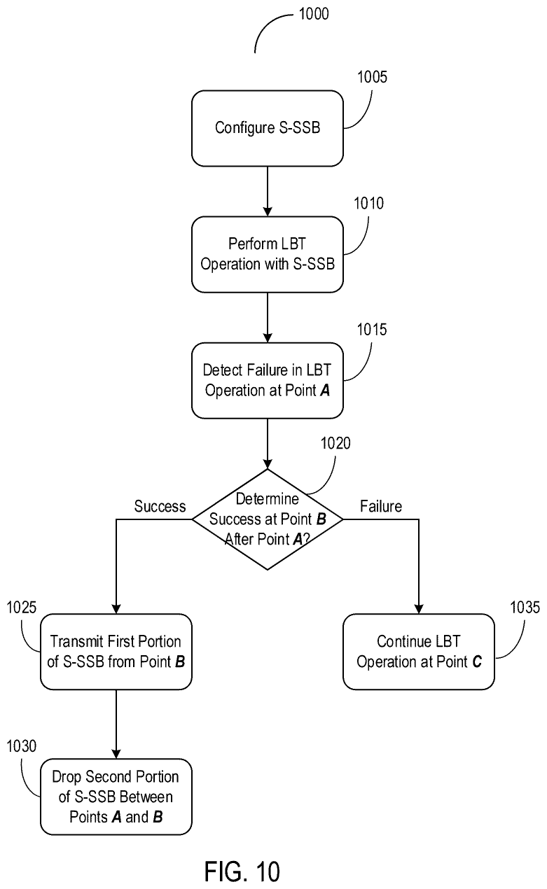

Referring now to FIG. 10, depicted is a flow diagram of a method 1000 of performing listen-before-talk (LBT) operations in sidelink communications. The method 1000 may be implemented or performed using any of the components described above, such as the BS 102 or 202 or UE 104 or 204, among others. In brief overview, a wireless communication device may configure a sidelink synchronization signal block (S-SSB) (1005). The wireless communication device may perform a LBT operation with respect to the S-SSB (1010). The wireless communication device may detect a failure in the LBT operation in a first point (“point A”) (1015). The wireless communication may determine whether the LBT operation is a success at a second point (“point B”) after the first point (1020). If the LBT operation is successful at the second point, the wireless communication device may transmit a portion of S-SSB from the second point (1025). The wireless communication device may also drop another portion of the S-SSB between the first point and the second point (1030). On the other hand, if the LBT operation is a failure at the second point, the wireless communication device may continue to perform LBT operation at a third point (referred to again as a second point in determining the transmission) (1035)

In further detail, a wireless communication device (e.g., UE 104 or 204) may define or otherwise configure a sidelink synchronization signal block (S-SSB) (1005). The S-SSB may include a set of resource elements or symbols defined across frequency and time for performing a listen-before-talk (LBT) operation. The S-SSB may identify or include a first part and a second part, among others. Each of the first and second parts may include a corresponding subset of resource elements or symbols for sidelink synchronization. The first part may duplicate, reiterate, or otherwise repeat one or more symbols from the second part in accordance with a configuration of the second part. In some embodiments, the first part may repeat the one or more symbols from the second part in accordance with a configuration of the first part.

The first part may correspond to a repetition range portion of the S-SSB (e.g., as depicted in FIGS. 5A-C), and may include a subset of symbols from the second part. In some embodiments, the first part of the S-SSB may repeat the one or more symbols of a type of a plurality of types for sidelink synchronization. The symbols may correspond to resource blocks or resource elements defined across frequency and time. The plurality of types may identify or include one or more of: a sidelink primary synchronization signal (S-PSS) or a sidelink secondary synchronization signal (S-SSS), among others. The one or more repeated symbols may start prior to an initial symbol of the physical sidelink broadcast channel (PSBCH) symbols in the second part in the S-SSB.

In some embodiments, the first part of the S-SSB may repeat a repetition range corresponding to the one or more symbols from the second part. The repetition range may be based on one or more of a number of symbols, subcarrier spacing, a number of RBs, or a number of interlaces for mapping, among others. The mapping may be between the one or more symbols in the first part with the one or more symbols in the second part of the S-SSB. The number of symbols may correspond to a quantity of S-PSS, S-SSS, or PSBCH symbols, among others. The subcarrier spacing (SCS) may correspond to a reciprocal of a symbol time in a given channel. The number of interlaces may correspond to a number of times a given set of symbols (e.g., S-PSS and S-SSS) is repeated in the repetition range of the S-SSB.

The S-SSB configured by the wireless communication device for the LBT operation may be outside a resource pool for at least one other S-SSB belonging to the resource pool. In some embodiments, a first number of S-SSBs not belonging to a resource pool and a second number of S-SSBs belonging to a resource pool may be separately configured or predefined. In some embodiments, a mapping ratio between the first number of S-SSBs not belonging to a resource and the second number of S-SSBs belonging to a resource pool is predefined. In some embodiments, the first number defined within a resource block (RB) set or a bandwidth part (BWP) that is different from or same as the second number of symbols.

The wireless communication device may carry out, execute, or otherwise perform a LBT operation with respect to the S-SSB (1010). The wireless communication device may perform the LBT operation in an unlicensed spectrum for S-SSB transmission in sidelink operation. In carrying out the operation, the wireless communication device may monitor for other or sense communications (e.g., signals or channels) within the unlicensed spectrum. From sensing, the wireless communication device may determine whether other communications are present the same resources (e.g., defined in time and frequency) as the S-SSB in the unlicensed spectrum.

The wireless communication device may determine, identify, or otherwise detect a failure in the LBT operation in a first point (“point A”) (1015). While performing the LBT operation, the wireless communication device may detect the failure when other communications are present on the same resources as the S-SSB in the monitored spectrum. With the detection of the failure, the wireless communication device may measure, determine, or otherwise identify the first point in time at which the failure occurred. The first point may be identified by the wireless communication device from a set of candidate starting points for the LBT operation, and the first point may be defined within a resource block (RB) set or a bandwidth part (BWP). The wireless communication device may continue to perform the LBT operation from the first point as reference.

The wireless communication may identify or determine whether the LBT operation is a success at a second point (“point B”) after the first point (1020). While performing the LBT operation, the wireless communication device may determine the LBT operation as successful when no other communications are present on the same resources as the S-SSB subsequent to the first point. With the determination of the success, the wireless communication device may measure, determine, or otherwise identify the second point in time at which the success is detected. The second point may be identified by the wireless communication device from the set of candidate starting points for the LBT operation (e.g., the same set as the first point), and the second point may be defined within a resource block (RB) set or a bandwidth part (BWP). Between the first and second points, in some embodiments, the first part of the S-SSB repeating the one or more symbols from the second part may start from an initial symbol index. In addition, the first part may end at a terminal symbol index, prior to an initial symbol of a physical sidelink broadcast channel (PSBCH).

Otherwise, when other communications are present on the same resources as the S-SSB, the wireless communication device may determine the LBT operation after the first point as a failure. With the determination of the failure, the wireless communication device may measure, determine, or otherwise identify the second point (also referred herein as a third point) in time until which the success is detected. The identification of the second point where LBT operation is successful shall continue with the process of performing LBT operation in a third point which is 9 us, 16 us or a symbol subsequent to the previous second point. The third point may be identified by the wireless communication device from the set of candidate starting points for the LBT operation (e.g., the same set as the first point), and the second point may be defined within a resource block (RB) set or a bandwidth part (BWP).

The first, second, and third points may be identified by the wireless communication device from the set of candidate starting points for the LBT operation. In some embodiments, a first number of candidate starting points for the LBT operation in a first RB set is smaller than a second number of candidate starting points in a second RB set. In some embodiments, a first location of at least one first candidate starting point for the LBT operation in a first RB set may be earlier than a second location of at least one second candidate starting point in a second RB set.

If the LBT operation is successful at the second point, the wireless communication device may send, provide, or otherwise transmit a portion of the S-SSB from the second point (1025). The portion of the SSB may be mapped to one or more time-domain resources (e.g., symbols or interval between symbols) starting from the second point. In some embodiments, the wireless communication device may transmit an entirety of the S-SSB mapped to the one or more time-domain resources, when the success is at the second point corresponding to the initial symbol index.

Relative to the resource pool, the portion of the S-SSB to be transmitted may be not associated with the resource pool for another set of S-SSB. In some embodiments, the transmission of the S-SSB may only apply to a second set of S-SSB. The second set of the S-SSB may be on the slots that are not mapped by a bitmap associated with the resource pool. In some embodiments, the transmission of the entirety of a first set of S-SSB may be performed when the second point corresponds to the initial symbol index. The first set of S-SSB may be on the slot which are mapped by the bitmap associated with the resource pool.

The wireless communication device may also release or otherwise drop another portion of the S-SSB between the first point and the second point from transmission (1030). In some embodiments, the wireless communication device may drop at least one symbol corresponding to the initial symbol index from transmission. The dropping of the symbol may be in response to: (i) the failure at the first point corresponding to the initial symbol index and (ii) the success at the second point corresponding to at least one index subsequent to the initial symbol index.

On the other hand, if the LBT operation is a failure at the second point, the wireless communication device may continue to perform LBT operation at a third point (1035). The third point may be, for example, 9 μs, 16 μs, or a symbol subsequent to the second point. If the LBT operation is successful, the third point may replace the second point and the transmission may start from the second point with the S-SSB symbols between the first and second point dropped. Otherwise, the LBT operation may continue at a point subsequent to the third point until the LBT operation is successful at a given point that replaces the second point. In some embodiments, the wireless communication device may determine a success in the LBT operation at the third point of the S-SSB subsequent to the first point. When the LBT operation is successful at the third point, the wireless communication device may transmit a second portion of the S-SSB having one or more resources (e.g., time-domain resources) or symbols starting from the third point.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method of performing listen-before-talk (LBT) operations in sidelink communications, comprising:
performing, by a wireless communication device, a LBT operation with respect to a sidelink synchronization signal block (S-SSB) having a first part and a second part, wherein the first part repeats one or more symbols from the second part according to a configuration of the second part;
determining, by the wireless communication device, a failure in the LBT operation at a first point in the S-SSB;
determining, by the wireless communication device, a success in the LBT operation at a second point of the S-SSB subsequent to the first point; and
transmitting, by the wireless communication device responsive to the success, at least a portion of the S-SSB mapped to one or more time-domain resources starting from the second point.

2. The method of claim 1, further comprising:
determining, by the wireless communication device, a second failure in the LBT operation at a third point of the S-SSB subsequent to the first point; and
transmitting, by the wireless communication device responsive to the success at the second point, a second portion of the S-SSB having one or more second time-domain resources starting from the second point.

3. The method of claim 1, further comprising:
determining, by the wireless communication device, a success in the LBT operation at a third point of the S-SSB subsequent to the first point; and
transmitting, by the wireless communication device responsive to the success at the third point, a second portion of the S-SSB having one or more second time-domain resources starting from the third point.

4. The method of claim 1, further comprising dropping, by the wireless communication device responsive to the success, a second portion of the S-SSB between the first point and the second point from transmission.

5. The method of claim 1, wherein the first part of the S-SSB repeats the one or more symbols of a type of a plurality of types for sidelink synchronization, the plurality of types comprising at least one of a sidelink primary synchronization signal (S-PSS) or a sidelink secondary synchronization signal (S-SSS).

6. The method of claim 1, wherein the first part of the S-SSB repeats the one or more symbols from the second part according to the configuration of the first part.

7. The method of claim 1, wherein the first part of the S-SSB repeating the one or more symbols from the second part starts from an initial symbol index and ends at a terminal symbol index, prior to an initial symbol of a physical sidelink broadcast channel (PSBCH).

8. The method of claim 1, wherein transmission of the S-SSB only applies to a second set of S-SSB, wherein the second set of S-SSB are on the slots which are not mapped by a bitmap associated with a resource pool.

9. (canceled)

10. The method of claim 1, wherein transmission of an entirety of a first set of S-SSB is to be performed when the second point corresponds to the initial symbol index, wherein the first set of S-SSB are on the slots which are mapped by a bitmap associated with a resource pool.

11. (canceled)

12. The method of claim 7, wherein transmitting further comprises transmitting, responsive to the success at the second point corresponding to the initial symbol index, an entirety of the S-SSB mapped to the one or more time-domain resources.

13. The method of claim 7, further comprising dropping, by the wireless communication device, at least one initial symbol corresponding to the initial symbol index from transmission responsive to:
(i) the failure at the first point corresponding to the initial symbol index and
(ii) the success at the second point corresponding to at least one index subsequent to the initial symbol index.

14. The method of claim 1, wherein the first part of the S-SSB repeats a repetition range corresponding to the one or more symbols from the second part based on at least one of a number of symbols, subcarrier spacing, a number of RBs or a number of interlaces for mapping.

15. The method of claim 1, wherein a first number of S-SSBs not belonging to a resource pool and a second number of S-SSBs belonging to a resource pool are separately configured or predefined.

16. The method of claim 1, wherein a mapping ratio between a first number of S-SSBs not belonging to a resource and a second number of S-SSBs belonging to a resource pool is predefined.

17. The method of claim 14, wherein the first number defined within a resource block (RB) set or a bandwidth part (BWP) is different from or same as the second number of symbols.

18. The method of claim 1, wherein the first point and the second point are identified from a plurality of candidate starting points for the LBT operation, each candidate starting point defined within at least one of a resource block (RB) set or a bandwidth part (BWP).

19. The method of claim 15, wherein a first number of candidate starting points for the LBT operation in a first RB set is smaller than a second number of candidate starting points in a second RB set.

20. The method of claim 15, wherein a first location of at least one first candidate starting point for the LBT operation in a first RB set is earlier than a second location of at least one second candidate starting point in a second RB set.

21. A wireless communications apparatus comprising a processor and a memory, wherein the processor is configured to read code from the memory and implement a method recited in claim 1.

22. A computer program product comprising a computer-readable program medium code stored thereupon, the code, when executed by a processor, causing the processor to implement a method recited in claim 1.
